(19) United States
(12) Patent Application Publication
(10) Pub. No.: US 2008/0314416 A1
(43) Pub. Date: Dec. 25, 2008

(54) Method and Composition For Removing Biological Fouling From Surfaces in Contact With Water

(75) Inventors: Ulrich Reimann-Philipp, Norman, OK (US); Jeffrey Schulhoff, Oklahoma City, OK (US)

Correspondence Address: EATON PEABODY PATENT GROUP, LLC, P.O. BOX 5249, 77 Sewall Street, Suite 3000, AUGUSTA, ME, 04332-5249, US

(73) Assignee: FLORAN TECHNOLOGIES INC., Oklahoma City, OK (US)

(21) Appl. No.: 11/997,602

(22) PCT Filed: Aug. 2, 2006
(86) PCT No.: PCT/US06/30321

§ 371 Date: Jun. 15, 2008

Related U.S. Application Data
(60) Provisional application No. 60/704,900, filed on Aug. 3, 2005.

(51) Int. Cl. B08B 3/08; C11D 3/395

(52) U.S. Cl. 134/28; 510/375; 510/199

(57) ABSTRACT

A composition and method for the removal of biological fouling from wetted surfaces intermittently or continuously in contact with water is disclosed. The method includes the steps of preparing a cleaning composition of basic pH from a strong base and an active oxygen donor component, applying the composition to the surface to be cleaned, and after a selected residence time, removing any unreacted cleaning composition and all removed fouling by rinsing or flushing with water.

### CROSS REFERENCE TO RELATED APPLICATIONS

This application claims priority from U.S. Provisional Application Ser. No. 60/704,900, filed Aug. 3, 2005, which is incorporated herein by reference in its entirety.

### FIELD OF THE INVENTION

The present invention is generally directed toward surface cleaning processes. More specifically, the present invention is directed toward a process for removing organisms, which attach to wetted surfaces, such as facilities and equipment used in the treatment and distribution of water, boat hulls, cooling towers or swimming pools.

### BACKGROUND OF THE INVENTION

The surface of any body, conduit, container or medium in contact with water will over time accumulate deposits of biological and non-biological material, which cannot be removed by flushing or backwashing and can significantly affect water flow past the contaminated surface. Severe contamination will significantly decrease performance especially in drinking water treatment facilities. Thus, it is important to clean wetted surfaces not only of loose particles removable by flushing or backwashing but also of the surface deposits. Depending on the water source and environmental conditions, these surface deposits, can consist of organic matter (biofilm), metal oxides, or calcium carbonate scale. Heavy fouling or scaling will eventually reduce water flow, filter performance, etc., and in general affect water throughput. The consequences can be higher backwash frequency, reduced flow-rates, increased water turbidity, corrosion, water contamination or a combination of these effects. If the deposits are not removed, performance will decline below tolerable levels and shut down may become necessary. Biological growth on surfaces includes microscopic biofilm, algal “lawns” and colonization by mussels, sponges or other sessile invertebrate animals.

Colonization in water-conducting facilities leads to reduced flow and lost capacity. One example is the formation of zebra mussel colonies in water intake structures and in water pipes. Sponges, Hydroids and Bryozoa grow on filter underdrains and greatly reduce filtration capacity. Algae grow on surfaces that are exposed to light and can contribute to increased dissolved organic matter content in filtered water.

Current methods for removing biological growth from surfaces can be grouped into mechanical and chemical methods. Mechanical methods include high-pressure washing, scraping and flushing and combinations thereof. Chemical surface treatments include the use of acids, bases and chlorine, alone or in combination with surfactants and detergents. These chemical treatments can be satisfactory for certain types of contamination, such as calcium carbonate scale. However, mixed deposits, which include metal oxides and biological films, are either not removed efficiently or require highly corrosive and hazardous cleaning agents which are difficult to use and may leave residue not acceptable, especially in drinking water processing installations. Biological deposits can also be controlled by adding biocides to the bulk water or preventive measures such as applying anti-fouling surface coatings or erecting barriers against entry of the organisms into the facility.

All these methods have shortcomings. Mechanical methods are limited by accessibility to the affected surfaces, potentially destructive effects of treatment and high labor and downtime cost. Chemical methods such as anti-fouling paints and biocidal water additives cannot be used in drinking water facilities or environmentally sensitive applications. Thus, a need exists for a method which offers efficient deposit removal together with safety and ease of application and applicability in drinking water facilities.

### SUMMARY OF THE INVENTION

It is an object of the invention to provide an economical and effective means of removing biological surface deposits from wetted surfaces. The term “wetted surface” as used herein defines any surface, which is permanently or periodically in contact with water.

The invention provides a method and composition for chemically removing biological fouling from wetted surfaces. The term ‘biological fouling’ as used herein includes biofilms such as algal lawns as well as colonies of organisms such as mussels, sponges or other sessile invertebrate animals. Examples are zebra mussels, sponges, hydroids and bryozoa.

The preferred method in accordance with the invention includes the steps of preparing a cleaning composition by mixing two separate components immediately before application and subsequently exposing the surface with biological fouling to the cleaning solution, preferably by spraying the cleaning composition onto the affected surfaces or by soaking the affected surfaces in the cleaning composition. The method preferably includes the further step of removing dislodged biological fouling together with residual cleaning chemicals through rinsing with water. The rinse water is preferably applied by flushing, spraying, pressure-washing or backwashing.

The preferred cleaning composition in accordance with the invention is a basic cleaning composition, which includes at least two components, a basic component, preferably in the form of a solution of basic pH, and an active oxygen donor. The basic solution preferably contains potassium hydroxide or sodium hydroxide or a blend thereof.

For the purpose of this disclosure, the term active oxygen donor defines compounds, which in aqueous solution decompose to generate oxygen radicals. Numerous active oxygen donors of this type are known and need not be listed in detail. The active oxygen donor is preferably selected from peroxides, most preferably hydrogen peroxide, peracetic acid, precursors of peroxides, hydrogen peroxide and peracetic acid and combinations thereof. The activator is most preferably either 0.1-20% hydrogen peroxide, or 0.1-10% peracetic acid, or a combination of hydrogen peroxide and peracetic acid, with the balance being water.

Additional optional ingredients, which can be included in the cleaning composition include defoaming agents, corrosion inhibitors and dyes. Surfactants facilitate the dispersal of the cleaning solution and support the dislodging of attached organisms. Defoaming agents are added to prevent spills and facilitate the rinsing step.

The components of the cleaning composition in accordance with the invention are preferably concentrated stock solutions or readily prepared solutions. Preferably, the cleaning solution is prepared by diluting concentrated stock solutions of the components to a desired final concentration in a mixing container at the site of application. The optional ingredients of the cleaning composition are preferably included in the basic component to avoid decomposition by oxygen radicals.

In a preferred embodiment of the basic cleaning composition, the basic component, active oxygen donor component and optional ingredients are selected as follows:

| KOH | 0.1-11M | |
|---|---|---|
| NaOH | 0.1-10 M | |
| Surfactant | 0-2% | (w/w) |
| Anti-foaming agent | 0-2% | (w/w) |
| H202 | 0.1-20% | (w/w)* |
| Peracetic acid | 0-5% | (w/w) |

*At Na)H concentrations ≧5M, the H202 concentration must be reduced to ≦1%.

In another preferred embodiment, the cleaning process of the invention is a combination treatment process, which includes the additional step of applying an acidic cleaning composition to the treatment surface for removal of mineral deposits on the treatment surface before or after the rinsing step. The acidic cleaning composition preferably includes at least two components, an acidic component and an active oxygen donor. Additional optional ingredients include surfactants, corrosion inhibitors, defoaming agents and dyes.

In still another preferred embodiment of the process of the present invention, the amounts of basic and acidic cleaning composition are selected such that the cleaning residue accumulated after application of both compositions and prior to the rinsing steps is substantially pH neutral.

In a preferred embodiment of the acidic cleaning solution, the acidic component is sulfamic acid. In another preferred embodiment, the acidic component includes at least one additional ingredient selected from the group of citric acid, phosphoric acid, corrosion inhibitor, free-flow additive and surfactant. Preferably the acidic cleaning composition includes the following components:

| Component | Volume (w/w) |
|---|---|
| sulfamic acid; | 50-99% |
| citric acid; | 0-10% |
| phosphoric acid; | 0-10% |
| corrosion inhibitor; | 0-10% |
| Free-flow additive; | 0-10% |
| surfactant; and | 0-10% |
| sodium bicarbonate | Balance |

The acidic cleaning composition can be in liquid form, such as the cleaning compositions disclosed in EP 1 196 033 incorporated herein in its entirety by reference, or in granular form such as the cleaning compositions disclosed in WO2006/021861, filed Aug. 22, 2005, incorporated herein in its entirety by reference.

In an especially preferred embodiment of the combination treatment process, the basic cleaning composition and the acidic cleaning composition are applied successively to a drinking water filtration media in a filter bed or simultaneously to different portions of a drinking water filtration installation.

### BRIEF DESCRIPTION OF THE DRAWINGS

Preferred embodiments of the invention will now be further described by way of example only and with reference to the attached drawings, wherein FIG. 1 is a schematic flow diagram of a preferred process in accordance with the present invention;

FIG. 2 is a schematic flow diagram of a variant of the process of FIG. 1; and

FIG. 3 is a schematic flow diagram of a combination treatment method in accordance with the invention.

### DETAILED DESCRIPTION

Before explaining the present invention in detail, it is to be understood that the invention is not limited to the preferred embodiments contained therein. The invention is capable of other embodiments and of being practiced or carried out in a variety of ways. It is to be understood that the phraseology and terminology employed herein are for the purpose of description and not of limitation.

FIG. 1 is a schematic flow diagram of a preferred embodiment of a process in accordance with the invention for the cleaning of wetted surfaces, for example any facilities and equipment used in the treatment and distribution of water, such as water conduits or water filtration media contained within a filtration bed, boat hulls, swimming pools, cooling towers, heat exchange media, etc. In this embodiment, the process includes a first, cleaning composition generation step 10, wherein a solution of a strong base component is mixed with an active oxygen donor component, and a second, cleaning composition application step 20, in which the resulting cleaning composition is applied to the wetted surface. In a reaction step 40, the base component chemically reacts in conjunction with the active oxygen donor component and the biological fouling on the wetted surface, resulting in the cleaning of the surface. The duration of reaction step 40 varies depending on the degree of contamination. However, the reaction step 40 is preferably carried out for at least 30 minutes, preferably one hour, most preferably the reaction step is conducted over night. Most preferably, the reaction step 40 is carried out until the wetted surface is completely cleaned. The point in time at which the surface is completely cleaned can be determined by visual inspection to check for any foaming which would indicate an ongoing cleaning reaction and/or by measuring the supernatant pH.

The inventors of the present process surprisingly discovered that the use of a strong base in combination with an active oxygen donor significantly improved cleaning efficiency and biological deposit removal over existing treatment methods, without the need for additional chemical or mechanical cleaning. This provides the process of the current invention with significant economical and practical advantages.

After the cleaning step 40, any residual cleaning composition is washed away along with the suspended and dissolved deposits which were removed from the wetted surface by rinsing with water in a rinsing step 50. The rinsing step can be carried out by spraying water onto the surface media or by flushing. The rinsing step 50 is best carried out until all residual cleaning composition and all dissolved and suspended bio-contaminants have been removed. Completion of the rinsing step 50 can be determined by monitoring the turbidity and, pH of the rinsate water, for example. Disposal of the rinsate can be carried out in various ways, depending on local regulations, but is preferably carried out according to WO2006/021861, which is incorporated herein in its entirety by reference.

Prior to the application step 20, the system facility or the like to be cleaned is preferably drained to expose the wetted surfaces to be cleaned. In the alternative, the cleaning composition is applied to the water in sufficient amount and concentration to achieve a reaction in the reaction step 40.

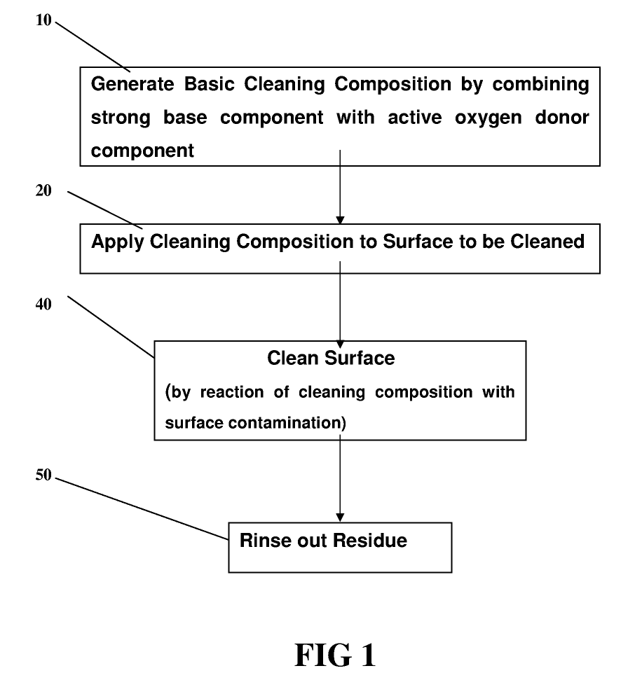

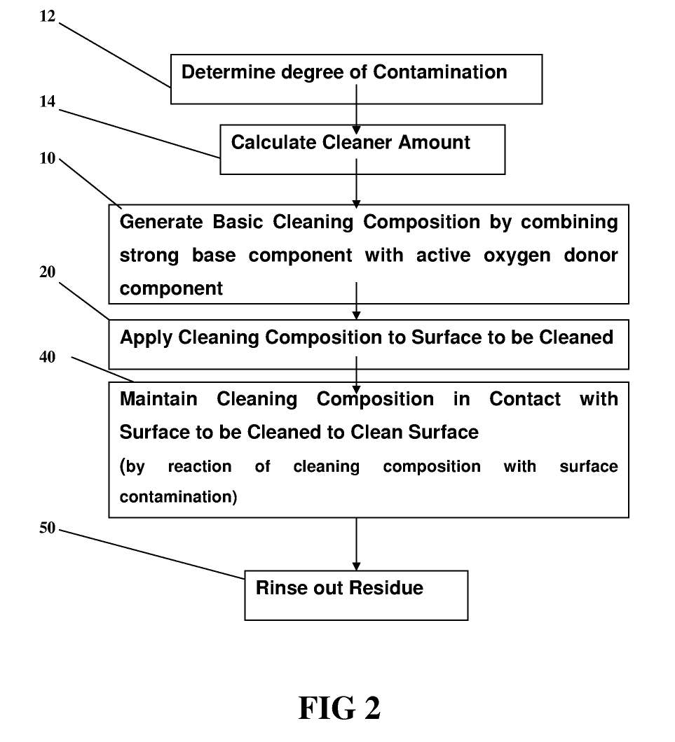

A further preferred embodiment of the process of the invention as illustrated in FIG. 2 includes an analysis step 10 for determining the degree of surface contamination on the wetted surface and a calibration step 12 for calculating the amount and composition of the cleaning composition to be applied for ensuring maximum effectiveness of the cleaning process and to minimize the amount of unreacted cleaning composition remaining after the reaction step 40. The analysis step preferably includes the step of selecting a representative sample area, the sample having a known size. The calibration step 12 preferably includes the steps of measuring the amount of cleaning composition required for substantially complete removal of the surface contaminants from the sample area and then extrapolating to the amount required for cleaning of the whole wetted surface to be cleaned. If the cleaning composition is used for the cleaning of granular filtration media, the analysis step includes the step of taking a representative core sample of known volume from the filtration media. The core sample is preferably taken in an area of maximum or at least average contamination. Extrapolation to the amount required for cleaning of the whole filtration media bed is achieved by multiplying the measured amount of cleaning composition required for cleaning of the sample by the ratio of filtration bed volume/sample volume. Adjusting the amount of cleaning composition used to the respective contamination conditions provides the process of the invention with a significant economical advantage, since substantially no excess cleaner will be used, reducing the cost of the cleaning materials as well as the cost of disposing of any unreacted basic component and active oxygen donor.

The cleaning composition of a preferred embodiment of the invention includes the strong base component, the active oxygen donor component and at least one additional component selected from the group of a surfactant for reducing surface tension and enhancing contact of the cleaning composition with the surface to be cleaned, an inhibitor for protecting exposed metal surfaces from the corrosion by the strong base component, and a coloring agent.

The strong base component of the preferred cleaning composition is either potassium hydroxide or sodium hydroxide, or combinations thereof.

Surfactants useful for inclusion in the cleaning composition in accordance with the invention can be selected from the group of anionic, cationic, nonionic and amphoteric surfactants. Useful anionic surfactants include, by way of non-limiting the example, alkaline metal salts, ammonium salts, amine salts, aminoalcohol salts, fatty acid salts. Particularly preferred surfactants are Thomadol 91-6 and Thomalkali surfactant (both available from Thoma Products, Inc.). For use in drinking water processing installations, surfactants are preferred which are NSF certifiable.

Corrosion inhibitors used for inclusion in the cleaning composition in accordance with the invention can be selected from those compatible with alkaline solutions. Preferred corrosion inhibitors are tolyltriazole- and benzotriazole-containing products.

Defoaming agents useful for inclusion in the cleaning composition in accordance with the invention can be selected from the group of silicone, non-silicone or emulsified oil defoaming agents. The most preferred defoaming agent is DSP antifoam emulsion (commercially available from Dow Corning).

The active oxygen donor component used in the cleaning composition in accordance with the invention is preferably selected from hydrogen peroxide, peracetic acid, precursors of hydrogen peroxide and peracetic acid and combinations thereof. Examples of granular precursors of activated oxygen donors applicable for use in the preparation of the cleaning composition in accordance with the invention are sodium percarbonate and BSC 8080, available from Buckman Laboratories. The active oxygen donor component is preferably either 0.1 to 20% hydrogen peroxide or 0 to 5% peracetic acid with the balance being water. The oxygen donor component can be in a liquid or dry state prior to its inclusion into the cleaning composition in the cleaning composition generation step 10.

The cleaning composition in accordance with the invention preferably includes the following components at the indicated amounts:

| KOH | 0.1-11M | |
|---|---|---|
| NaOH | 0.1-10 M | |
| Surfactant | 0-2% | (w/w) |
| Anti-foaming agent | 0-2% | (w/w) |
| H202 | 0.1-20% | (w/w)* |
| Peracetic acid | 0-5% | (w/w) |

*At NaOH concentrations ≧5M, the H202 concentration must be reduced to ≦1%.

As will be readily understood from the indicated volume ranges, all compounds having a volume range with a lower value of 0 are optional components.

Exemplary formulations illustrating preferred embodiments of the above general cleaning composition are described in detail in the following:

### EXAMPLE 1

| NaOH | 0.1-10 M | |
|---|---|---|
| Surfactant | 0-2% | (w/w) |
| Anti foaming agent | 0-2% | (w/w) |
| H₂O₂ | 0.1-10% | (w/w)* |
| Peracetic acid | 0-5% | (w/w) |

*At NaOH concentrations of ≧5M the H₂O₂ concentrations have to be reduced to ≦1%.

### EXAMPLE 2

| KOH | 0.1-11 M | |
|---|---|---|
| Surfactant | 0-2% | (w/w) |
| Anti foaming agent | 0-2% | (w/w) |
| H₂O₂ | 0.1-20% | (w/w)* |
| Peracetic acid | 0-5% | (w/w) |

### EXAMPLE 3

| NaOH/KOH combined | 0.1-10 M | |
|---|---|---|
| Surfactant | 0-2% | (w/w) |
| Anti foaming agent | 0-2% | (w/w) |
| H₂O₂ | 0.1-10% | (w/w)* |
| Peracetic acid | 0-5% | (w/w) |

*At NaOH concentrations of ≧5M the H₂O₂ concentrations have to be reduced to ≦1%.

The individual constituents of the cleaning compositions described herein are commercially available from various sources including those described in McCutcheon's Functional Materials (Vol. 2), North American Edition, 1991; and in Kirk-Othmer, Encyclopedia of Chemical Technology, 3^{rd} Edition, Vol. 22, the contents of which are incorporated herein by reference. For any particular cleaning composition, the optional components used should be compatible with all other ingredients included in the composition.

In the application step 20, the cleaning composition in accordance with the invention is applied to the surface to be cleaned by soaking the surface in the cleaning solution for at least 30 minutes, or by spraying the cleaning solution onto the surface, preferably by low pressure spraying. The rinsing step 50 can be carried out by spraying, high pressure washing, flushing or backwashing, especially when cleaning filtration media.

When the cleaning composition in accordance with the invention is used for the cleaning of a water line, the cleaning composition is applied by soaking the water line for at least 30 minutes and removing any residual unreacted cleaning composition and the dislodged surface deposits by flushing of the treated waterline with water. For the cleaning of filter media, the cleaning composition is preferably sprayed onto the top of the filter bed after the bed has been drained and all residual unreacted cleaning composition as well as the dislodged surface deposits are removed by backwashing the filter.

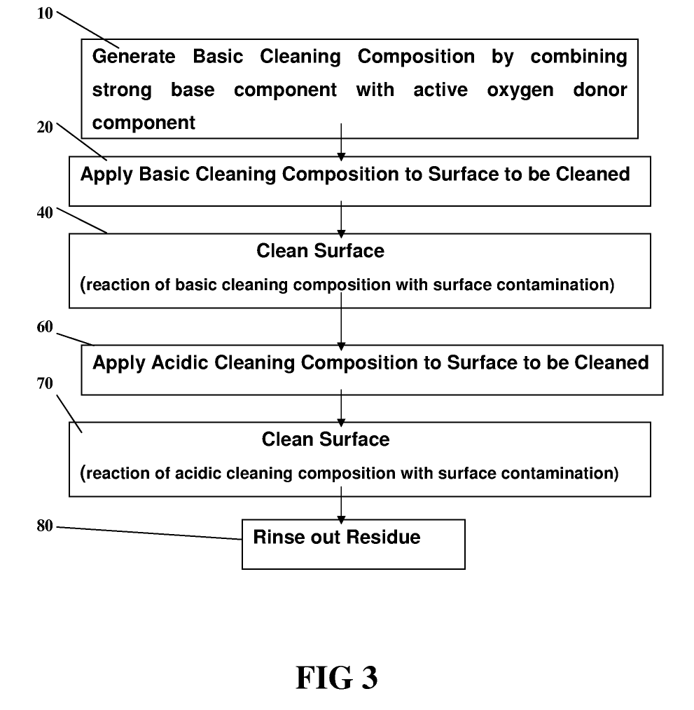

The basic cleaning composition of the present invention can also be used in a combination treatment process as illustrated schematically in FIG. 3, in which the basic cleaning composition is used in combination with an acidic cleaning composition to achieve removal of biological fouling as well as mineral deposits. The combination treatment process includes the basic cleaning composition generation step 10, the basic cleaning composition application step 20 and the reaction step 40 as described above in relation to FIG. 1. The combination process further includes the additional steps of a second application step 60 in which an acidic cleaning composition is applied to the treatment surface for removal of mineral deposits on the treatment surface, and a second reaction step 70 in which the acidic cleaning composition is maintained in contact with the surface to be cleaned. The combination process also includes a rinsing step 80 in which any unreacted cleaning composition and any removed deposits and fouling are washed away by rinsing with water. The rinsing step 80 can be carried out in a similar manner to the rinsing step 50 discussed above by spraying water onto the treated surface or by flushing. Although the combination process in accordance with the invention preferably includes both the rinsing step 50 and the second rinsing step 80, the rinsing stop 50 can be omitted. The second rinsing step 80 is best carried out until all residual cleaning composition and all dissolved deposits and suspended bio-contaminants have been removed. Completion of the second rinsing step 80 can be determined as in the rinsing step 50 by monitoring the turbidity and, pH of the rinsate water, for example. If both rinsing steps are carried out, the disposal of the rinsate from the second rinsing step 80 is preferably combined with the disposal of the rinsate from rinsing step 50. In particular, both rinsates are preferably captured and combined in the same container, such as a lagoon, for at least a partial pH neutralization. Preferably, rinsing step 50 is carried out before application of the acidic cleaning composition. If the rinsing step 50 is omitted, all residual cleaning composition, both basic and acidic, is removed together with all dissolved scaling and removed fouling and washed away in the second rinsing step 80. This renders the process more economical.

The acidic cleaning composition preferably includes at least two components, an acidic component and an active oxygen donor. Additional optional ingredients include surfactants, corrosion inhibitors, defoaming agents and dyes. Preferred acidic cleaning compositions for use in the present combination process are disclosed in EP 1 196 033.

The preferred acidic component is sulfamic acid, at least one additional ingredient selected from the group of citric acid, phosphoric acid, corrosion inhibitor, free-flow additive and surfactant. Preferably the acidic cleaning composition includes the following components:

| Component | Volume (w/w) |
|---|---|
| sulfamic acid; | 50-99% |
| citric acid; | 0-10% |
| phosphoric acid; | 0-10% |
| corrosion inhibitor; | 0-10% |
| Free-flow additive; | 0-10% |
| surfactant; and | 0-10% |
| sodium bicarbonate | Balance |

The acidic cleaning composition can be in liquid form, such as the cleaning compositions disclosed in EP 1 196 033, or in granular form such as the cleaning compositions disclosed in WO2006/021861. For the cleaning of filtration media in water treatment installations, use of the granular acidic composition is preferred.

In an especially preferred embodiment of the combination treatment process, the basic cleaning composition and the acidic cleaning composition are applied successively or simultaneously to a drinking water filtration media in a filter bed. The basic and acidic cleaning compositions may also be applied to different portions of a drinking water filtration installation. For example, since biological fouling is usually a bigger problem with water nozzles and conduits rather than the filtration media, the acidic cleaning composition can be applied to the top of the filtration bed and the basic cleaning composition to the bottom of the filtration media above the water plenum and nozzles usually found below the filtration bed. Application to the bottom of the filtration media can be achieved by way of pipes or lancets inserted into the media to the desired level at which application is to occur.

While the invention has been described with a certain degree of particularity, it is understood that the invention is not limited to the embodiments set forth herein for purposes of exemplification, but is to be limited only by the scope of the attached claims, including the full range of equivalency to which each element thereof is entitled.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for removing biological fouling from wetted surfaces intermittently or continuously in contact with water, comprising of the steps of:
a. Preparing a cleaning composition by mixing of a basic component and an active oxygen donor component;
b. Applying the cleaning composition to a surface to be cleaned;
c. Allowing the composition to react; and
d. Removing any residual, unreacted cleaning composition and any removed biological fouling.

2. The method as described in claim 1, wherein the cleaning composition is applied by soaking the surface to be cleaned in the cleaning composition.

3. The method as defined in claim 1, wherein the cleaning composition is applied by low-pressure spraying.

4. The method as defined in claim 1, wherein the residual cleaning composition and the removed biological fouling are removed by high-pressure water washing.

5. The method as defined in claim 1, wherein the wetted surface to be cleaned is the granular fill of a filter bed and the residual cleaning composition and the removed biological fouling are removed by initiating backwash of the filter bed.

6. The method as defined in claim 1, wherein the surface to be cleaned is a water line and the residual cleaning composition and the removed biological fouling are removed by flushing the water line.

7. The method as defined in claim 1, wherein the surface to be cleaned is in a water treatment, water storage or water conducting facility.

8. The method as defined in claim 1, wherein the surface to be cleaned is a boat hull, a cooling tower or a swimming pool.

9. The method as defined in claim 1, wherein the biological growth to be removed includes hydozoa, bryozoa, sponges, mollusks, algae or microbial films.

10. The method as defined in claim 9, wherein the biological growth to be removed includes algae and microbial films.

11. The method as defined in claim 1, comprising the additional step of applying an acidic cleaning composition to the treatment surface for removal of mineral deposits on the treatment surface before or after the rinsing step, the acidic cleaning composition including at least two components, an acidic component and an active oxygen donor.

12. The method as defined in claim 11, wherein the amounts of basic cleaning composition and acidic cleaning composition are selected such that cleaning residue accumulated after application of both compositions is substantially pH neutral.

13. The method as defined in claim 11, wherein the acidic cleaning composition is applied either before or after the step of removing any residual, unreacted basic cleaning composition and any removed biological fouling.

14. A cleaning composition for removal of biological fouling from wetted surfaces, comprising at least two components, a strong base component and an active oxygen donor component, which are shipped and stored separately and mixed upon application.

15. The cleaning composition as defined in claim 11, wherein the strong base component is 0.5M to 10M sodium hydroxide and the active oxygen donor component is 0.1% to 10% hydrogen peroxide.

16. The cleaning composition as defined in claim 11, wherein the strong base component is 0.5M to 11.4M potassium hydroxide and the active oxygen donor component is 0.1% to 20% hydrogen peroxide.

17. The cleaning composition as defined in claim 11, wherein the strong base component contains a blend of sodium hydroxide and potassium hydroxide.

18. A cleaning composition for removal of biological deposits from wetted surfaces, prepared by mixing a concentrated stock solution of a strong base component with an active oxygen donor component and water in a mixing container at a site of application of the composition.

19. The cleaning composition as defined in claim 15, wherein the active oxygen donor component is peracetic acid or a combination of peracetic acid and hydrogen peroxide.

20. The cleaning composition as defined in claim 15, wherein the active oxygen donor component is supplied in the form of a granular precursor of hydrogen peroxide, such as sodium percarbonate, or a granular precursor of peracetic acid, or combinations thereof.

21. The cleaning composition as defined in claim 15, further comprising 0.2-2.0% (w/w) of a non-ionic, cationic, anionic, low foam or no foam surfactant.

22. The cleaning composition as defined in claim 15, further comprising 0.25-2.0% (w/w) of a de-foaming agent.

23. The cleaning composition as defined in claim 15, further comprising 0.25-2.0% (w/w) of a corrosion inhibitor.

24. The cleaning composition as defined in claim 23, wherein the corrosion inhibitor is a tolyltriazole- or benzotriazole-containing product.
